(19) United States
(12) Patent Application Publication
(10) Pub. No.: US 2011/0173098 A1
(43) Pub. Date: Jul. 14, 2011

(54) SYSTEM, METHOD, COMPUTER READABLE MEDIUM AND COMPUTER PROGRAM PRODUCT FOR MANAGING ELECTRONIC COMMERCE

(76) Inventor: Chun-Yi Lee, Taipei City (TW)

(21) Appl. No.: 12/685,727

(22) Filed: Jan. 12, 2010

(51) Int. Cl. G06Q 30/00; G01C 21/34; G06F 17/30

(52) U.S. Cl. 705/27.1; 701/202; 707/769; 707/E17.014; 705/26.1

(57) ABSTRACT

The invention relates to a system, method, computer readable medium, and computer program product for managing electronic commerce to make users spend the least times, go to the nearest and fewest sales channel and buy the cheapest or suitable goods in order to save money, time, effort and energy. The system comprises an input module configured to receive at least one keyword request from a user client; a search module configured to search at least one goods record according to the keyword request in a database or on the Internet; a selection module configured to show the at least one goods record searched by the search module, receive an input, and perform a corresponding operation according to the input; a result module configured to show at least one shopping plan got from the correspondingly operation; a database configured to store goods records; and an order module configured to operate a shopping order.

### BACKGROUND OF THE INVENTION

1. Field of the Invention

The present invention relates in general to an electronic commerce, especially the area of managing electronically search and shopping, and in particular to a system and a method for managing electronic commerce. Still more particularly, the present invention relates to a computer readable medium and a computer program product for performing a method for managing electronic commerce.

2. Description of the Related Art

Modern sales channel becomes more and more important in trade, especially in a modern physical channel and a modern virtual channel. The modern physical channel has replaced mostly traditional physical channel in the developed world, said modern physical channel includes hypermarket chains, supermarket chains, convenient chain stores, drug and/or cosmetic chain stores, department stores, etc. On the other hand, the modern virtual channel grows more rapidly, said modern virtual channel includes an online shopping, a television shopping, a telephone shopping, a catalog shopping, a mobile shopping, etc.

Firstly, in most shopping behavior, the decision making of buying some basic goods is cheapness, said basic goods are such as meat, seafood, poultry, vegetable, fruit, bread, etc., because most of them are no-brand goods, modern sales channel controls goods quality well or the buying decision of some consumers is only cheapness. Secondly, in some common goods, some consumers always alternatively buy within few brands, such as, only 2 famous brands are their alternatives while buying cola, especially, some consumers will alternatively buy the promoted one while a branded goods is priced off. Finally, some consumers may be not familiar to some brands or goods, they will begin to find suitable goods from cheap goods upon to acceptably branded goods, such as, while buying television, some consumers will find suitable television since cheap one upon to acceptably branded one in order to get a better balance point between price and brand for saving cost and effectively using money.

According to the above, an electronic commerce typically does not work well as follows:

Firstly, a regular situation is variously promotional information makes most consumers difficult to collect and compare thereof well, said situation makes most consumers feel confused in promotional information and often buy a goods or a set of goods with not the cheapest cost in a “feel-cheap” store rather than a “real-cheapest” store. Most modern sales channels often promote their cheap-price image, however, no store sales the cheapest price in all goods while comparing their sale price, especially, when some goods are promotionally priced off in some stores, the goods usually are sold in the cheapest price.

Secondly, mostly online shopping only search with a single-goods keyword request once, and then the found and suitable goods information will be put in shopping cart for ordering respectively. Recently most online shopping are not able to compare various goods-related information for consumers' real needs and not able to provide consumers suitable shopping recommendations, especially in searching plural goods once.

Thirdly, while people stay and buy goods in an unfamiliar place, such as a travel or biz trip in other cities or abroad, they won't know any store nearby, furthermore, they also won't know which near store they can buy wanted goods with the cheapest price. The above situation makes they buy goods in first-sight store and neglect a price factor cause of unfamiliar and not time to compare, especially in common goods.

Fourthly, mostly modern sales channels provide consumers goods information, such as a promotional advertisement, with a B2C model pushing all goods information to consumers, however, each consumer doesn't need all goods information and probably buy less than 20% goods of all information. On the other hand, the rest goods information becomes a disturber while reading and also wastes many environmental resource in print; and

Finally, some people probably go to many stores for collecting information or buying the cheapest goods in order to save money, however, they often spend much time and effort, waste transportation energy and make air pollution.

### BRIEF SUMMARY OF THE INVENTION

The technical problem underlying the invention is to provide a system and a method for managing electronic commerce, and to provide a computer readable medium, and a computer program product to perform the method for managing electronic commerce, which are able to make users spend the least times, go to the nearest and fewest sales channel and buy the cheapest or suitable goods in order to save money, time, effort and energy.

The invention solve this problem by providing a system for managing electronic commerce having the features of claim 1 or 3, a method for managing electronic commerce having the features of claim 4, 7, 18 or 19, a computer readable medium for performing a method for managing electronic commerce having the features of claim 10 or 11, and a computer program product for performing a method for managing electronic commerce having the features of claim 12, 13 or 13.1. Advantageous embodiments of the invention are mentioned in the sub claims.

Accordingly, in an embodiment of the present invention, a system for managing electronic commerce includes the following: an input module configured to receive at least one keyword request from a user client; a search module configured to search at least one goods record according to the keyword request in a database or on the Internet; a selection module configured to show the at least one goods record searched by the search module, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; a result module configured to show at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme; a database configured to store goods records; and an order module configured to operate a shopping order.

In a further embodiment of the present invention, the database configured to store data with a table and categorize data attribute with at least one field name, wherein the at least one field name comprises at least one of a goods, a brand, a channel, a price, a place, a date, an advice, a picture, an activity and a blank block, wherein the field name of the goods comprises at least one of a goods category, a goods name, a feature, a capacity, a purchase unit and a purchase quantity, wherein the field name of the brand comprises at least one of a brand name, a brand value and a brand value rank, wherein the field name of the channel comprises at least one of a channel name, a store name, a store address, a store telephone and a store operating time, wherein the field name of the price comprises at least one of a regular price, a special price, a club price, a price gap, a lowest price/smallest unit, a sum, a total, an unit price, a saving and a scheme saving, wherein the field name of the place comprises at least one of a departure location and a store address, wherein the field name of the date comprises at least one of a purchase date, an activity period, a good buy and a price good, wherein the field name of the advice comprises at least one of a price advice and a brand advice, wherein the field name of the activity comprises at least one of an activity summary and an activity period, and wherein the field name of the blank block comprises at least one of a goods keyword block, a goods selection block, a purchase quantity block, a price selection block, a brand selection block, a departure location block and a purchase date block.

In another embodiment of the present invention, a system for managing electronic commerce includes the following: an input module configured to receive at least one keyword request from a user client; a search module configured to search at least one goods record according to the keyword request, and perform a corresponding operation under the at least one goods record; a result module configured to show at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map; and an order module configured to operate a shopping order.

In an embodiment of the present invention, a method for managing electronic commerce, providing a set of selectable defined offerings, includes the following: performing an input operation, receiving at least one keyword request; performing a search operation, searching at least one goods record according to the keyword request in a database or on the Internet; performing a selection operation, showing the at least one goods record searched by the search operation, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; performing a result operation, showing at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme; and performing an order operation, operating a shopping order.

In a further embodiment of the present invention, the search operation includes the following: searching at least one goods record according to the keyword request in the database or on the Internet; determining whether related goods record is found according to the keyword request; showing could not finding matches for the keyword request if the related goods record is not found; and retrieving the related goods record and setting the related goods record as a candidate for performing the selection operation if the related goods record is found.

In a further embodiment of the present invention, the selection operation includes the following: showing at least one goods record searched by the search operation; determining whether receiving a response or not; still waiting for the response if the response is not received; waiting for further response after performing the corresponding operation designated by the received response if the response is received and the received response designated the corresponding operation other than the confirming operation; and setting result obtained by performing the corresponding operation as one of candidates for performing the result operation if the response is received and the received response designated the confirming operation.

In another embodiment of the present invention, a method for managing electronic commerce, providing a set of selectable defined offerings, includes the following: performing an input operation, receiving at least one keyword request; performing a search operation, searching at least one goods record according to the keyword request, and perform a corresponding operation under the at least one goods record; performing a result operation, showing at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map ; and performing an order operation, operating a shopping order.

In a further embodiment of the present invention, the search operation includes the following: searching at least one goods record according to the keyword request; determining whether related goods record is found according to the keyword request; showing could not finding matches for the keyword request if the related goods record is not found; and retrieving the related goods record and setting the related goods record as one of candidates for performing the result operation if the related goods record is found.

In further embodiments of the present invention, the input operation includes the following: receiving the at least one keyword request; determining whether receiving a response or not; still waiting for the response if the response is not received; and receiving the keyword request and providing the keyword request as a parameter for performing the search operation if the response is received.

In an embodiment of the present invention, the computer-readable medium tangibly embodying a program of machine-readable instructions executable by a digital processing apparatus to perform a method of managing electronic commerce includes the following: performing an input operation, receiving at least one keyword request; performing a search operation, searching at least one goods record according to the keyword request in a database or on the Internet; performing a selection operation, showing the at least one goods record searched by the search operation, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; performing a result operation, showing at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme; and performing an order operation, operating a shopping order.

In another embodiment of the present invention, the computer-readable medium tangibly embodying a program of machine-readable instructions executable by a digital processing apparatus to perform a method of managing electronic commerce includes the following: performing an input operation, receiving at least one keyword request; performing a search operation, searching at least one goods record according to the keyword request, and perform a corresponding operation under the at least one goods record; performing a result operation, showing at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map; and performing an order operation, operating a shopping order.

In an embodiment of the present invention, the computer program product for managing electronic commerce includes the following: a computer usable medium having computer usable program code embodied therewith, the computer usable program code comprising computer usable program code configured to: performing an input operation, receiving at least one keyword request; performing a search operation, searching at least one goods record according to the keyword request in a database or on the Internet; performing a selection operation, showing the at least one goods record searched by the search operation, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; performing a result operation, showing at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme; and performing an order operation, operating a shopping order.

In another embodiment of the present invention, the computer program product for managing electronic commerce includes the following: a computer usable medium having computer usable program code embodied therewith, the computer usable program code comprising computer usable program code configured to: performing an input operation, receiving at least one keyword request; performing a search operation, searching at least one goods record according to the keyword request, and perform a corresponding operation under the at least one goods record; performing a result operation, showing at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map; and performing an order operation, operating a shopping order.

In another embodiment of the present invention, the computer program product for managing electronic commerce includes the following: a computer usable medium having computer usable program code embodied therewith, the computer usable program code comprising computer usable program code configured to: selecting a sort principle of plural searched goods records of at least one goods, wherein the sort principle comprises one of a lowest-price principle, a lowest-price-under-brand principle, a brand-value principle and a lowest-price-with-highest-brand-value principle, wherein the lowest-price principle sorts the plural searched goods records having the same goods name with field contents of the price in ascending order, wherein the lowest-price-under-brand principle sorts the plural searched goods records having the same brand name and the same goods name with field contents of the price in ascending order, wherein the brand-value principle sorts the plural searched goods records having the same goods name with field contents of the brand value in descending order, wherein the lowest-price-with-highest-brand-value principle sorts the plural searched goods records having the same goods name with field contents of the brand value in descending order and then sort with field contents of the price in ascending order, and wherein a field name corresponding to the field contents of the price comprises at least one of a regular price, a special price, a club price, a price gap, a lowest price/smallest unit, a sum, a total, an unit price, a saving and a scheme saving.

In further embodiments of the present invention, the operation of the goods sorting includes at least one of selecting sort principle and selecting record quantity. The selecting sort principle configured to select a sort principle of plural searched goods records of at least one goods, wherein the sort principle comprises one of a lowest-price principle, a lowest-price-under-brand principle, a brand-value principle and a lowest-price-with-highest-brand-value principle. The selecting record quantity configured to select for showing a record quantity of the plural searched goods records of each goods.

In further embodiments of the present invention, the operation of the hierarchy transferring configured to show relationships and field contents of hierarchies of the at least one goods record, and provide to transfer a goods hierarchy location within the hierarchies, wherein a field name corresponding to the field contents of the hierarchies comprises at least one of a goods category, a goods name, a feature, a capacity, a purchase unit and a brand name.

In further embodiments of the present invention, the operation of the field arranging configured to arrange a field name in order to change a show of the searched goods records, wherein the arranging comprises one of moving prioritily, adding and reducing, and wherein the field name comprises at least one of a goods, a brand, a channel, a price, a place, a date, an advice, a picture, an activity and a blank block.

In an embodiment of the present invention, a method for managing electronic commerce includes selecting a sort principle of plural searched goods records of at least one goods, wherein the sort principle comprises one of a lowest-price principle, a lowest-price-under-brand principle, a brand-value principle and a lowest-price-with-highest-brand-value principle, wherein the lowest-price principle sorts the plural searched goods records having the same goods name with field contents of the price in ascending order, wherein the lowest-price-under-brand principle sorts the plural searched goods records having the same brand name and the same goods name with field contents of the price in ascending order, wherein the brand-value principle sorts the plural searched goods records having the same goods name with field contents of the brand value in descending order, wherein the lowest-price-with-highest-brand-value principle sorts the plural searched goods records having the same goods name with field contents of the brand value in descending order and then sort with field contents of the price in ascending order, and wherein a field name corresponding to the field contents of the price comprises at least one of a regular price, a special price, a club price, a price gap, a lowest price/smallest unit, a sum, a total, an unit price, a saving and a scheme saving.

In an embodiment of the present invention, a method for managing electronic commerce includes: showing at least one suggested scheme, wherein the at least one suggested scheme comprises at least one of a one-store scheme, a lowest-price scheme, a best-brand-value scheme, a fewest-and-nearest-plural-stores scheme and a store map.

The above, as well as additional purposes, features and advantages of the present invention will become apparent in the following detailed written description, when considered with the attached drawings and appended claims.

### BRIEF DESCRIPTION OF THE SEVERAL VIEWS OF THE DRAWINGS

A preferred embodiment of the invention, as described in detail below, is shown in the drawings, in which:

FIG. 1A is a simplified block diagram illustrating the transactions between a client and an electronic commerce system according to an embodiment of the present invention;

FIG. 1B is a simplified block diagram illustrating a database according to an embodiment of the present invention;

FIG. 2A is a flow chart describing an electronic commerce method and system according to an embodiment of the present invention;

FIG. 2B is a flow chart describing an electronic commerce method and system according to another embodiment of the present invention;

FIG. 3A is an input module Web page according to an embodiment of the present invention;

FIG. 3B is a selection module Web page according to an embodiment of the present invention;

FIG. 3C is a selection module Web page according to another embodiment of the present invention;

FIG. 3D is a result module Web page according to an embodiment of the present invention;

FIG. 3E is an order module Web page according to an embodiment of the present invention;

FIG. 4A is a database table according to an embodiment of the present invention;

FIG. 4B is another database table according to an embodiment of the present invention;

FIG. 4C is another database table according to an embodiment of the present invention;

FIG. 5 is a pop-up window of goods sort operation according to an embodiment of the present invention;

FIG. 6 is a pop-up window of hierarchy transfer operation according to an embodiment of the present invention; and

FIG. 7 is a pop-up window of field arrange operation according to an embodiment of the present invention.

### DETAILED DESCRIPTION OF THE PRESENTLY PREFERRED EMBODIMENTS OF THE INVENTION

According to the present invention, a system, method, computer readable medium, and computer program product for managing electronic commerce is provided. In an exemplary embodiment, the present invention provides a method for managing electronic commerce to make users spend the least times, go to the nearest and fewest sales channel and buy the cheapest or suitable goods in order to save money, time, effort and energy. The electronic commerce may also include an electronic search service and an electronic shopping service. The modern sales channel may also include a modern physical channel and a modern virtual channel. The goods may also be a goods or a set of plural goods. The goods are widely goods, and may also include products and services. The saving money may also be to buy goods with the cheapest or cheaper price. The saving time and effort may also be to spend the least times, go to the nearest and fewest sales channel and buy goods. The saving energy may also be to concern with the one-store scheme buying goods in one store in order to save transportation energy. The suitable may also be users choose wanted goods themselves. The method can be implemented on an individual computer or a network of computers. The network of computers can be a local area network, a wide area network, an intranet, an extranet, or the Internet. Merely by way of example, the invention is illustrated using the Internet, but it is recognized that the invention can also be applied to personal computers, a local area network, a wide area network, an intranet, and an extranet.

In the description that follows, the present invention is explained in reference to a further embodiment that operates on a client-server network using HTTP messages. The network can be an intranet, an extranet or the Internet. Therefore, the description of a further embodiment that follows is intended to be illustrative, but not limiting, of the scope of the present invention as set forth in the claims.

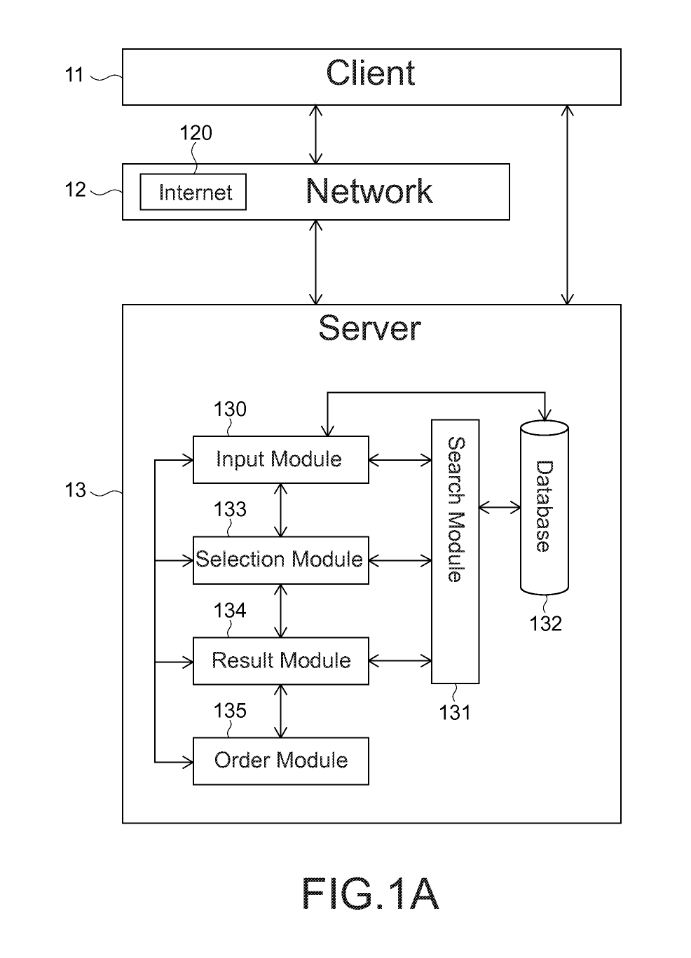

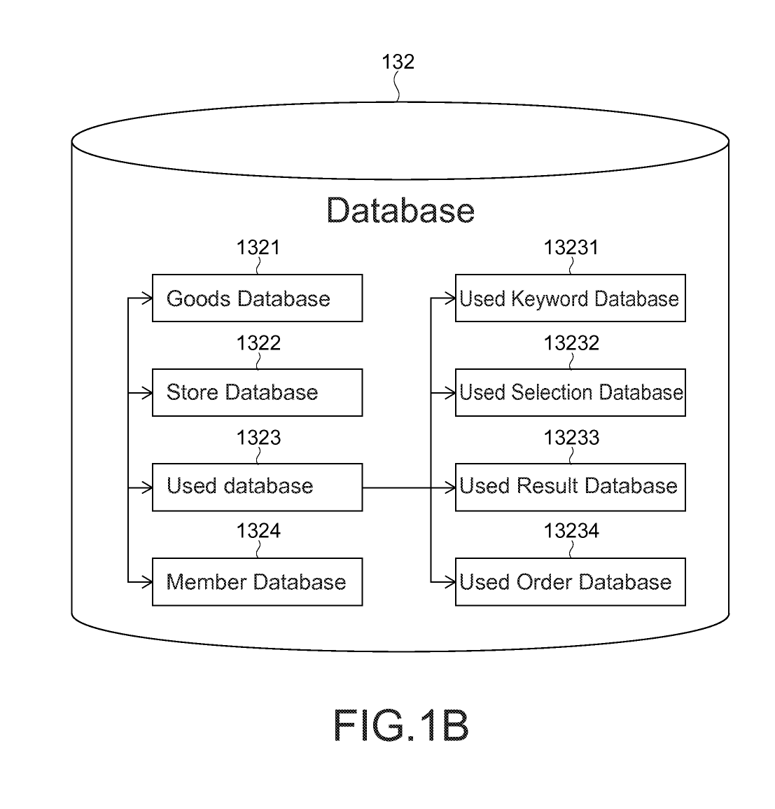

FIG. 1A is a simplified block diagram illustrating the transactions between a client and an electronic commerce system according to an embodiment of the present invention. The system for managing electronic commerce includes a server 13.

The server 13 includes the following: an input module 130 configured to receive at least one keyword request from a user client 11, wherein the at least one keyword request comprises at least one of an operator and at least one goods, wherein said at least one goods comprises at least one of a goods or a set of plural goods. Users connect to the input module 130 directly or through a network 12 from the client 11 for transacting message. The client 11 comprises at least one of a computer, a mobile phone, a personal digital assistant (PDA), an e-book reader, a set-top box (STB) and a kiosk. The network 12 can be any suitable network such as a wide area network, a local area network or a combination of a wide and local area network, and is also able to comprise at least one of the Internet 120, the cloud, a mobile Internet, a mobile communication, a cable, a satellite, a broadband and a terrestrial broadcasting.

A search module 131 configured to search at least one goods record according to the keyword request in a database 132 or on the Internet 120. The at least one goods record is categorized data attribute thereof with a field name corresponding to field contents thereof, wherein the field name comprises at least one of a goods, a brand, a channel, a price, a place, a date, an advice, a picture and an activity, wherein the field name of the goods comprises at least one of a goods category 402, a goods name 403, a feature 407, a capacity 408 and a purchase unit 409, wherein the field name of the brand comprises at least one of a brand name 404, a brand value and a brand value rank, wherein the field name of the channel comprises at least one of a channel name 401, a store name, a store address, a store telephone and a store operating time, wherein the field name of the price comprises at least one of a regular price 410, a special price 411, a club price, a price gap 413, a lowest price/smallest unit 414, a sum 423, a total 430, an unit price 435, a saving 431 and a scheme saving 432, wherein the field name of the place comprises at least one of a departure location 450 and a store address, wherein the field name of the date comprises at least one of a purchase date 453, an activity period 416, a good buy 417 and a price good 433, wherein the field name of the advice comprises at least one of a price advice 419 and a brand advice 420, and wherein the field name of the activity comprises at least one of an activity summary and an activity period 416.

A selection module 133 configured to show the at least one goods record searched by the search module, receive an input, and perform a corresponding operation according to the input. Said searched at least one goods record is to show at least one goods record in goods selection 400. Said corresponding operation comprises at least one of adding 335, saving 336, store inputting 337, a goods sorting 338, hierarchy transferring 339, field arranging 360, refine searching 361, refine calculating 362, goods selecting 331, purchase quantity inputting 421, price selecting 424, brand selecting 426, departure location inputting 450, purchase date inputting 453 and confirming 363.

The goods selection 400 is to show searched goods records with a table and categorize them with field names. The operation of add 335 is to make users to combine a historical data added from a used selection database 13232 and/or a new keyword request added in a goods keyword block 311. The operation of save 336 is to store recent information for using next time. The operation of store 337 is to make users search goods-related information in wanted sales channels, the basic setting is all channels.

The operation of goods sort 338 includes at least one of selecting sort principle 510 and selecting record quantity 530. The selecting sort principle 510 configured to select a sort principle 510 of plural searched goods records of at least one goods, wherein the sort principle 510 comprises one of a lowest-price principle, a lowest-price-under-brand principle, a brand-value principle and a lowest-price-with-highest-brand-value principle.

The lowest-price principle sorts the plural searched goods records having the same goods name 403 with field contents of the price in ascending order. For example, a system and method will automatically set the searched goods records with a lowest-price principle if there is no brand name 404 in a keyword request.

The lowest-price-under-brand principle sorts the plural searched goods records having the same brand name 404 and goods name 403 with field contents of the price in ascending order. For example, a system and method will automatically set the searched goods records with a lowest-price-under-brand principle if there are a brand name 404 and a goods name 403 in a keyword request.

The brand-value principle sorts the plural searched goods records having the same goods name 403 with field contents of the brand value in descending order. For example, data of the brand value can be referred from global research information.

The lowest-price-with-highest-brand-value principle sorts the plural searched goods records having the same goods name 403 with field contents of the brand value in descending order and then sort with field contents of the price in ascending order. A field name corresponding to the field content of price comprises at least one of a regular price 410, a special price 411, a club price, a price gap 413, a lowest price/smallest unit 414, a sum 423, a total 430, an unit price 435, a saving 431 and a scheme saving 432, and the better mode is the lowest price/smallest unit 414.

The selecting record quantity 530 configured to select for showing a record quantity of the plural searched goods records of each goods, such as top 3, top 5, top 7, top 10, top 15, top 20 or all, and its basic setting is to show “top 3” quantity of goods records.

The operation of the hierarchy transfer 339 shows relationships and field contents of hierarchies of the at least one goods record, and provides to transfer a goods hierarchy location within the hierarchies in order to fast find a wanted goods. A field name corresponding to the field contents of the hierarchies comprises at least one of a goods category 402, a goods name 403, a feature 407, a capacity 408, a purchase unit 409 and a brand name 404. The relationships and field contents are more detailed while more closing to the goods. The relationship is showed with a lineage. The operation of the field arrange 360 configured to arrange a field name in order to change a show of the searched goods records in a goods selection 400. The arranging comprises one of moving prioritily, adding and reducing. The field name comprises at least one of a goods, a brand, a channel, a price, a place, a date, an advice, a picture, an activity and a blank block, wherein the field name of the goods comprises at least one of a goods category 402, a goods name 403, a feature 407, a capacity 408, a purchase unit 409 and a purchase quantity 421, wherein the field name of the brand comprises at least one of a brand name 404, a brand value and a brand value rank, wherein the field name of the channel comprises at least one of a channel name 401, a store name, a store address, a store telephone and a store operating time, wherein the field name of the price comprises at least one of a regular price 410, a special price 411, a club price, a price gap 413, a lowest price/smallest unit 414, a sum 423, a total 430, an unit price 435, a saving 431 and a scheme saving 432, wherein the field name of the place comprises at least one of a departure location 450 and a store address, wherein the field name of the date comprises at least one of a purchase date 453, an activity period 416, a good buy 417 and a price good 433, wherein the field name of the advice comprises at least one of a price advice 419 and a brand advice 420, wherein the field name of the activity comprises at least one of an activity summary and an activity period 416, and wherein the field name of the blank block comprises at least one of a goods keyword block 311, a goods selection block 332, a purchase quantity block 422, a price selection block 425, a brand selection block 427, a departure location block 451 and a purchase date block 454. The operation of refine search 361 is to search information again. The operation of refine calculation 362 is clicked to immediately calculate field contents of a total 430 and/or saving 431 of goods again while being not yet updated automatically.

The purchase quantity is inputted by users with wanted goods quantity and includes at least one of a field name of purchase quantity 421 and a purchase quantity block 422, on the other hand, the purchase quantity block 422 will be automatically showed with quantity if the purchase quantity has been already in the above keyword request. The departure location 450 is inputted by users with an address, city, state or zip code of departure place in order to find a store, and includes at least one of a departure location block 451 and a departure location control block 452. Input module 130 will automatically set the operating place to be a departure location with global positioning system (GPS) if users do not input information in a departure location block 451 in mobile phone. Users may also click a departure location control block 452 to select an used data of departure location in a member database 1324. The purchase date 453 is inputted by users with an intended shopping date in order to search and buy wanted goods with a value price within an activity period, and includes at least one of a purchase date block 454 and a purchase date control block 455. Input module 130 will automatically set an operating date (e.g. today) to be an intended shopping date if users do not input information in the purchase date block 454. Users may also click a purchase date control block 455 to select an intended shopping date in a calendar.

A result module 134 configured to show at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme. Users can use said shopping plan to be a shopping guide while going shopping in a sales channel or keep on shopping in order module 135. The self-choice scheme 342 is that users choose a wanted-goods result themselves in selection module 133, and said at least one suggested scheme will be explained in detail with embodiments afterward.

A database 132 configured to store related data with a table and categorize related data attribute with at least one field name, wherein the related data is at least one goods record of plural sales channels, wherein the database 132 comprises at least one of a goods database 1321, a store database 1322, a used database 1323 and a member database 1324. The data in the database 132 comes from manually typing-in, automatically transacted from sales channel or automatically searching on the Internet 120. The data updated in the database 132 comprises at least one of a manually typing update or an automatically program update. The database 132 will be explained in detail with embodiments afterward.

An order module 135 configured to operate a shopping order.

In another embodiment of the present invention, a system for managing electronic commerce includes the following: an input module 130 configured to receive at least one keyword request from a user client 11, wherein the at least one keyword request comprises at least one of an operator and at least one goods, wherein said at least one goods comprises at least one of a goods or a set of plural goods; a search module 131 configured to search at least one goods record according to the keyword request, and perform a corresponding operation under the at least one goods record on the Internet 120, wherein the at least one goods record is categorized data attribute thereof with a field name corresponding to field contents thereof, wherein the field name comprises at least one of a goods, a brand, a channel, a price, a place, a date, an advice, a picture and an activity; a result module 134 configured to show at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map; and an order module 135 configured to operate a shopping order. It is an object of the electronic commerce to also be able to search goods-related information directly on the Internet 120, provide at last one suggested scheme and accept an order after receiving a keyword request.

FIG. 1B is a simplified block diagram illustrating a database according to an embodiment of the present invention. In a further embodiment of the present invention, a database 132 comprises at least one of a goods database 1321, a store database 1322, a used database 1323 and a member database 1324.

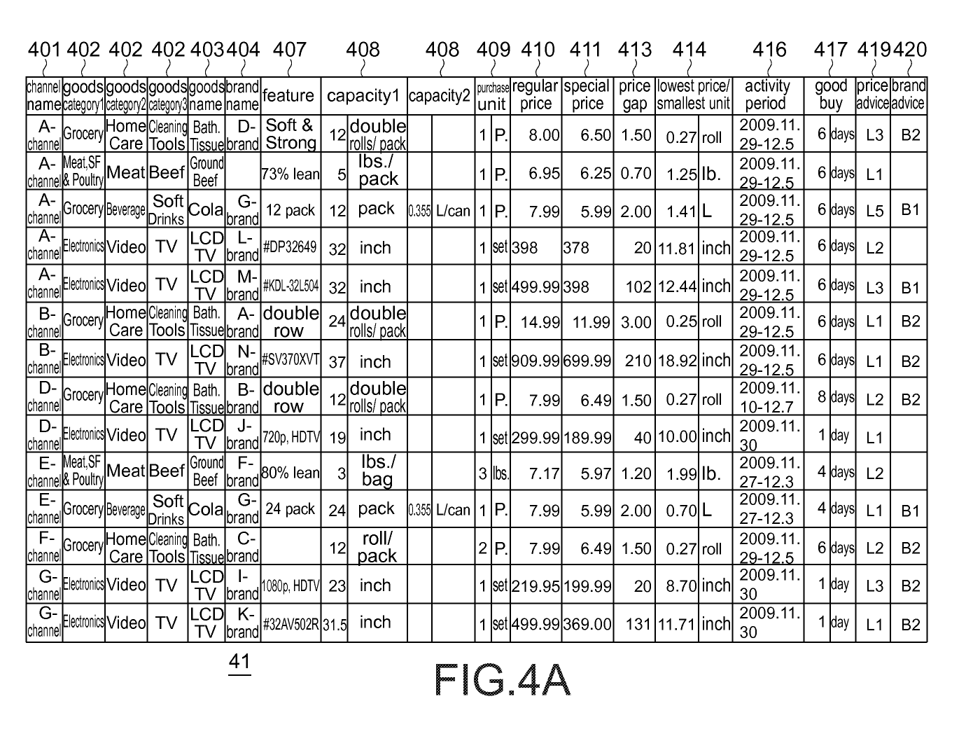

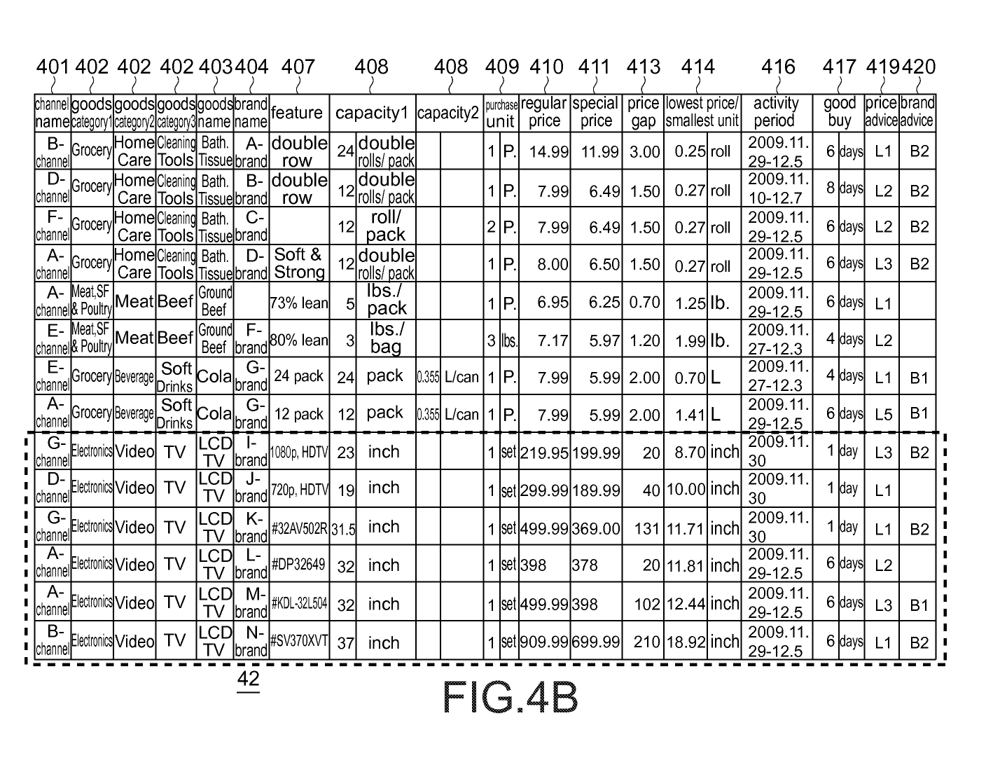

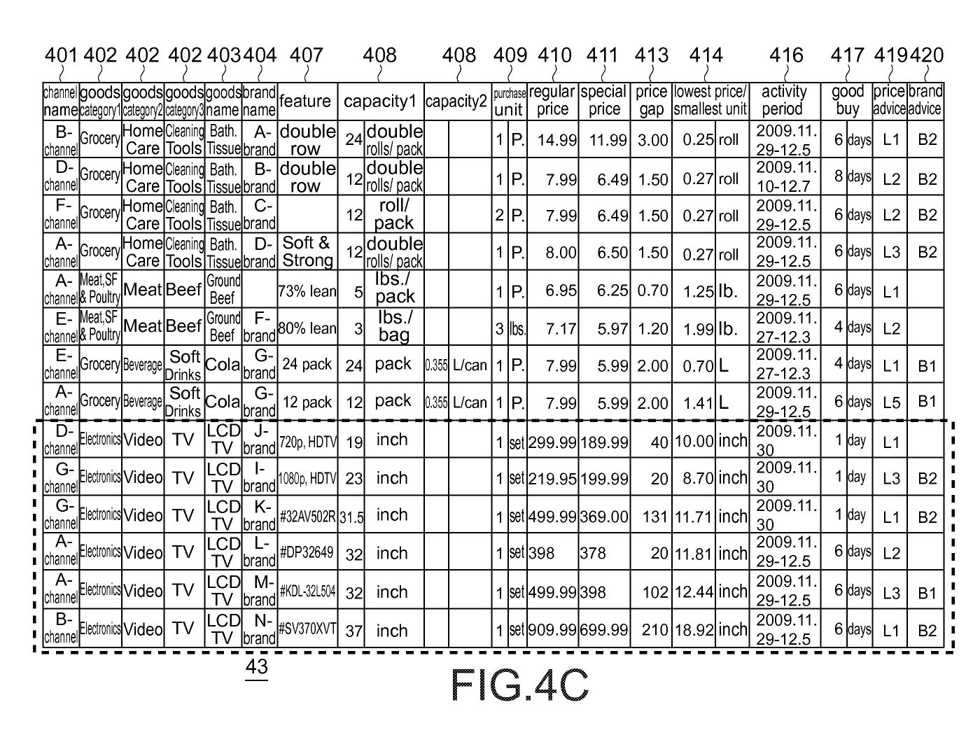

FIG. 4A is a database table according to an embodiment of the present invention. The goods database 1321 is to save goods records for searching, arranging and comparing, and the system can easily search suitable goods records by connecting to the goods database 1321, the goods database 1321 configured to store data with a table and categorize data attribute with a field name, wherein the field name comprises at least one of a goods, a brand, a channel, a price, a place, a date, an advice, a picture, an activity and a blank block, wherein the field name of the goods comprises at least one of a goods category 402, a goods name 403, a feature 407, a capacity 408, a purchase unit 409 and a purchase quantity 421, wherein the field name of the brand comprises at least one of a brand name 404, a brand value and a brand value rank, wherein the field name of the channel comprises at least one of a channel name 401, a store name, a store address, a store telephone and a store operating time, wherein the field name of the price comprises at least one of a regular price 410, a special price 411, a club price, a price gap 413, a lowest price/smallest unit 414, a sum 423, a total 430, an unit price 435, a saving 431 and a scheme saving 432, wherein the field name of the place comprises at least one of a departure location 450 and a store address, wherein the field name of the date comprises at least one of a purchase date 453, an activity period 416, a good buy 417 and a price good 433, wherein the field name of the advice comprises at least one of a price advice 419 and a brand advice 420, wherein the field name of the activity comprises at least one of an activity summary and an activity period 416, and wherein the field name of the blank block comprises at least one of a goods keyword block 311, a selection block 331, a purchase quantity block 422, a price selection block 425, a brand selection block 427, a departure location block 451 and a purchase date block 454. The channel means a channel of trades. The unit price 435 is a real sales price for users to buy goods and usually is the lowest or lower price, such as the special price 411 or the club price. The saving 431 is the total gap price between the highest sales price and the lowest sales price of total goods in a scheme. The scheme saving 432 is the total gap price between a suggested scheme and a self-choice scheme 342. The price advice 419 shows a sort number by sorting with such as a lowest-price principle and showed as L1, L2, L3, etc. The brand advice 420 shows a sort number by sorting with such as a brand-value principle and showed as B1, B2, B3, etc.

The store database 1322 is to save store related data, a field name of said store database 1322 comprises at least one of a channel name 401, a store name, a store address, a store telephone and a store operating time.

The used database 1323 is to save users' historically using related data for referring or retrieving to search next time, and includes at least one of a used keyword database 13231, a used selection database 13232, a used result database 13233 and a used order database 13234. The used keyword database 13231 is saved while using in input module 130; the used selection database 13232 is saved while using in selection module 133, the used result database 13233 is saved while using in result module 134 and the used order database 13234 is saved while using in order module 135.

The member database 1324 is to save members' related data, and a data of said member database 1324 comprises at least one of a member basic information, a member's store card information and a member departure location 450.

In a further embodiment of the present invention, the at least one suggested scheme of the result module 134 comprises at least one of a one-store scheme 3431, a lowest-price scheme 3432, a best-brand-value scheme, a fewest-and-nearest-plural-stores scheme and a store map 344.

The one-store scheme 3431 is a recommended scheme of buying goods with the cheapest or cheaper price in one store or website in order to save money, time, effort and energy. The method of the one-store scheme 3431 is to recommend users the cheapest or cheaper selected or substitute goods in which one store or website according to a principle of sort principle 510 in an operation of goods sort 338 and/or users' shopping behavior to sort and/or recommend a scheme from searched goods-related information. The users' shopping behavior can be referred with self-choice scheme 342.

The lowest-price scheme 3432 is a recommended scheme of buying goods with the cheapest price without consider if going to many stores in order to save money. The method of the lowest-price scheme 3432 is to recommend users the cheapest selected or substitute goods in any store or website according to a lowest-price principle and/or users' shopping behavior to sort and/or recommend a scheme from searched goods-related information.

The best-brand-value scheme is a recommended scheme of buying the highest-brand-value goods with the cheapest or cheaper price. The method of The best-brand-value scheme is to recommend users according to a lowest-price-with-highest-brand-value principle and/or users' shopping behavior to sort and/or recommend a scheme from searched goods-related information. Additionally, the one-store scheme 3431 can also be combined into the highest-brand-value scheme for convenience.

The fewest-and-nearest-plural-stores scheme is a recommended scheme of buying goods with the cheapest or cheaper price in the nearest and fewest plural stores or websites while could not buying all wanted goods in a store or a website. For instance, while users plan to eat a grilled steak for a dinner in restaurant, then go to a movie, and then go shopping for a television and telephone, sometimes, users are hardly buy all goods in a store and need a solution of the fewest-and-nearest-plural-stores scheme. The method of the fewest-and-nearest-plural-stores scheme is as similar as the one-store scheme 3431 to try the best to buy in a store or website, but not limited to only one store or website while could not buying all wanted goods in a store or a website.

The store map 344 is a recommended scheme of showing the nearest stores of each sales channel nearby a departure location 450 for users to buy goods, the better mode is to make the departure location 450 to be a central point and find the nearest store in each branded sales channel.

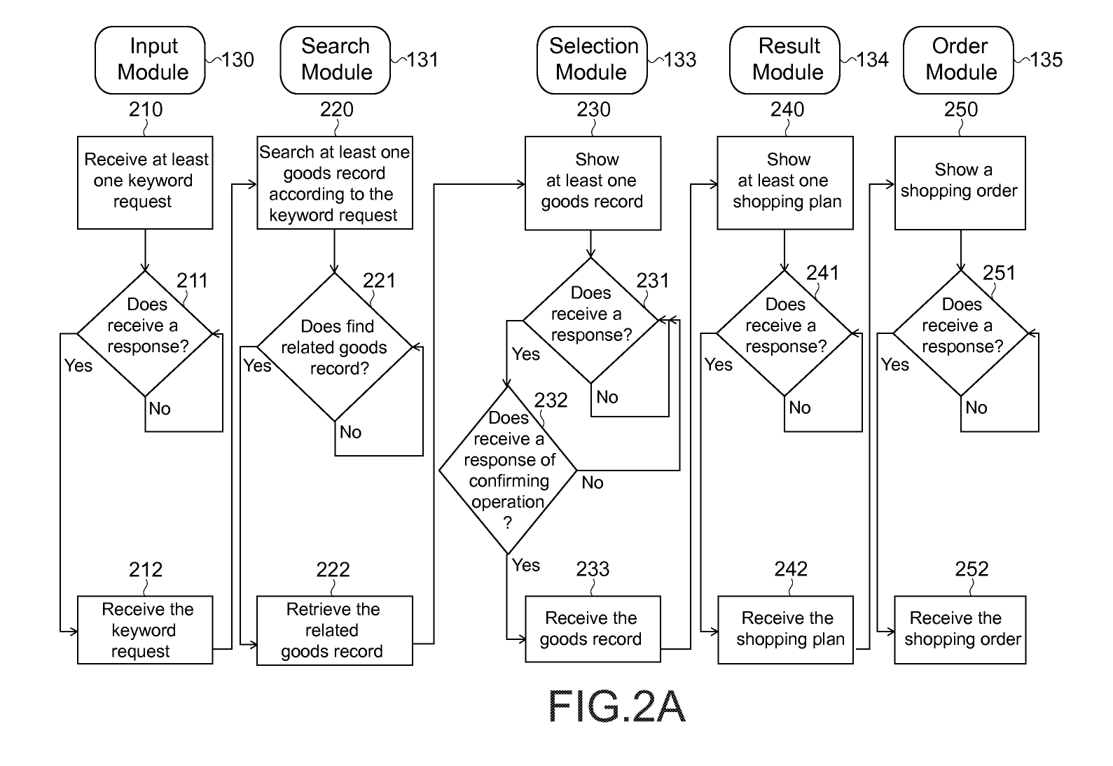

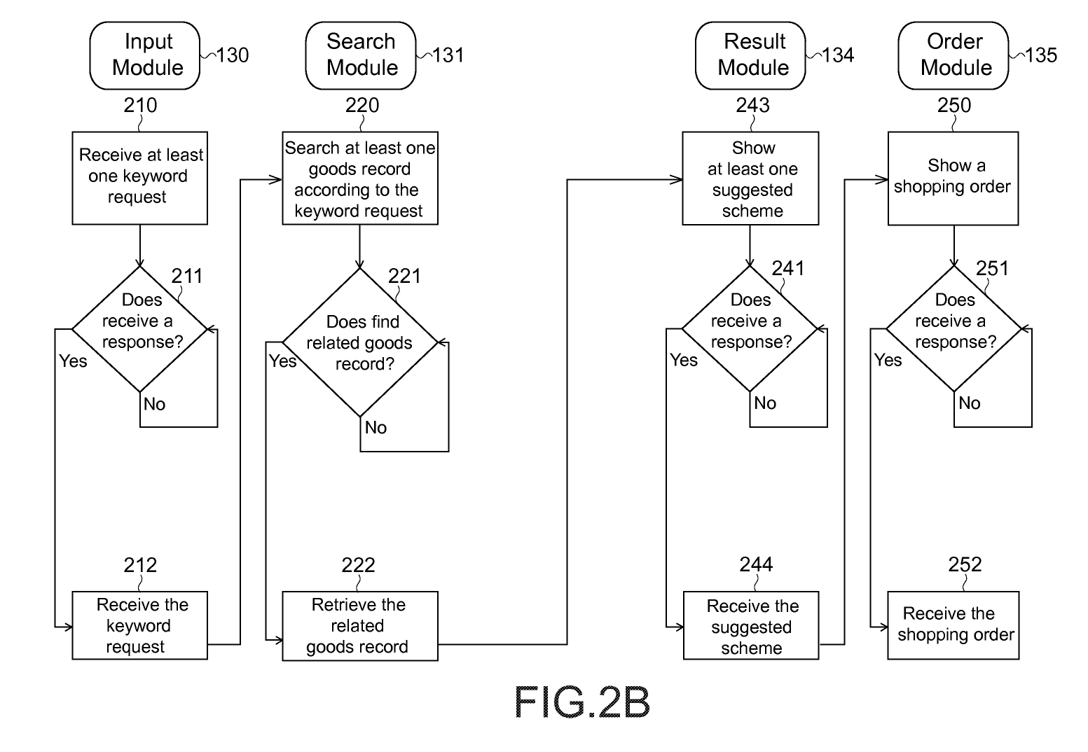

FIG. 2A is a flow chart describing an electronic commerce method and system according to an embodiment of the present invention. This diagram is merely an example and should not limit the scope of the claims herein. One of ordinary skill in the art would recognize other variations, modifications and alternatives. The method for managing electronic commerce, providing a set of selectable defined offerings, includes the following:

Performing an Input Operation

In step 210, input module 130 receives at least one keyword request comprising at least one an operator and at least one goods from a user client 11, wherein said at least one goods comprises one of a goods and a set of plural goods. Users may also add a history data from a used keyword database 13231 for further searching. In step 211, the input module 130 determines whether receiving a response or not, wherein said response comes from a search 312 operation and/or the keyword request. The input module 130 still waits for the response if the response is not received. In step 212, the input module 130 receives the keyword request and provides the keyword request as a parameter for performing the search operation if the response is received.

Performing a Search Operation

In step 220, search module 131 searches at least one goods record according to the keyword request in a database 132 and/or on the Internet 120, wherein data attribute of the goods record is categorized with a field name corresponding to filed contents, wherein the field name comprises at least one of a goods, a brand, a channel, a price, a place, a date, an advice, a picture and an activity. The database 132 is such as goods database 1321 thereof. In step 221, the search module 131 determines whether related goods record is found according to the keyword request. The search module 131 shows could not finding matches for the keyword request if the related goods record is not found. In step 222, the search module 131 retrieves the related goods record and sets the related goods record as a candidate for performing the selection operation if the related goods record is found.

Performing a Selection Operation

In step 230, selection module 133 shows the at least one goods record searched by the search operation. Users may also add a history data from a used selection database 13232. In step 231, the selection module 133 determines whether receiving a response or not. The selection module 133 still waits for the response if the response is not received. In step 232, waiting for further response after performing the corresponding operation designated by the received response if the response is received and the received response designated the corresponding operation other than the confirming operation. In step 233, the selection module 133 sets result obtained by performing the corresponding operation as one of candidates for performing the result operation if the response is received and the received response designated the confirming operation.

Performing a Result Operation

In step 240, result module 134 shows at least one shopping plan. In step 241, the result module 134 determines whether receiving a response or not, wherein said response comes from a shopping cart 341 operation. The result module 134 still waits for the response if the response is not received. In step 242, the result module 134 receives the shopping plan and provides the shopping plan as a parameter for performing the order operation if the response is received.

Performing an Order Operation

In step 250, order module 135 shows a shopping order. In step 251, the order module 135 determines whether receiving a response or not, wherein said response comes from the operation of a shipping & payment 351, a packing 352 and/or a place order 353. The order module 135 still waits for the response if the response is not received. In step 252, the order module 135 receives the shopping order if the response is received.

FIG. 2B is a flow chart describing an electronic commerce method and system according to another embodiment of the present invention. This diagram is merely an example and should not limit the scope of the claims herein. One of ordinary skill in the art would recognize other variations, modifications and alternatives. A method for managing electronic commerce, providing a set of selectable defined offerings, includes the following:

Performing an Input Operation

In step 210, input module 130 receives at least one keyword request comprising at least one an operator and at least one goods from a user client 11, wherein said at least one goods comprises one of a goods and a set of plural goods. In step 211, the input module 130 determines whether receiving a response or not wherein said response comes from a search 312 operation and/or the keyword request. The input module 130 still waits for the response if the response is not received. In step 212, the input module 130 receives the keyword request and provides the keyword request as a parameter for performing the search operation if the response is received.

Performing a Search Operation

In step 220, search module 131 searches at least one goods record according to the keyword request on the Internet 120, wherein data attribute of the goods record is categorized with a field name corresponding to filed contents, wherein the field name comprises at least one of a goods, a brand, a channel, a price, a place, a date, an advice, a picture and an activity. In step 221, the search module 131 determines whether related goods record is found according to the keyword request. The search module 131 shows could not finding matches for the keyword request if the related goods record is not found. In step 222, the search module 131 retrieves the related goods record and sets the related goods record as a candidate for performing the result operation if the related goods record is found.

Performing a Result Operation

In step 243, result module 134 shows at least one suggested scheme. In step 241, the result module 134 determines whether receiving a response or not, wherein said response comes from a shopping cart 341 operation. The result module 134 still waits for the response if the response is not received. In step 244, the result module 134 receives the suggested scheme and provides the suggested scheme as a parameter for performing the order operation if the response is received.

Performing an Order Operation

In step 250, order module 135 shows a shopping order. In step 251, the order module 135 determines whether receiving a response or not, wherein said response comes from the operation of a shipping & payment 351, a packing 352 and/or a place order 353. The order module 135 still waits for the response if the response is not received. In step 252, the order module 135 receives the shopping order if the response is received.

In an embodiment of the present invention, the computer-readable medium tangibly embodying a program of machine-readable instructions executable by a digital processing apparatus to perform a method of managing electronic commerce includes the following: performing a method as above embodiments of the present invention.

In an embodiment of the present invention, the computer program product for managing electronic commerce includes the following: a computer usable medium having computer usable program code embodied therewith, the computer usable program code comprising computer usable program code configured to: performing a method as above embodiments of the present invention.

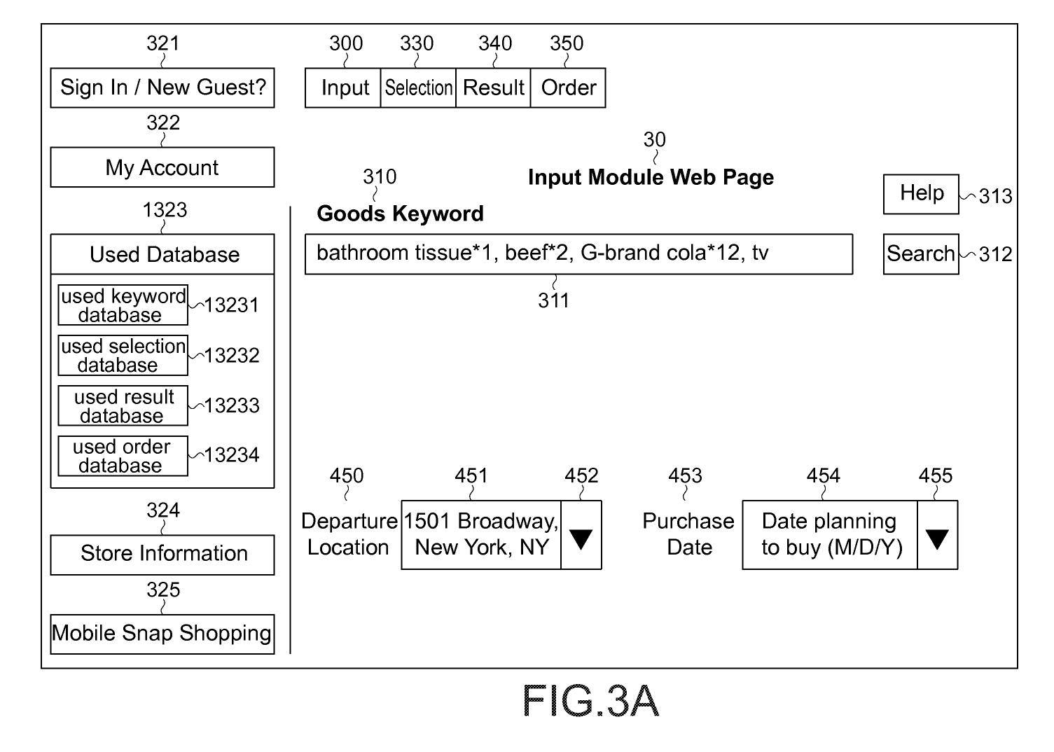

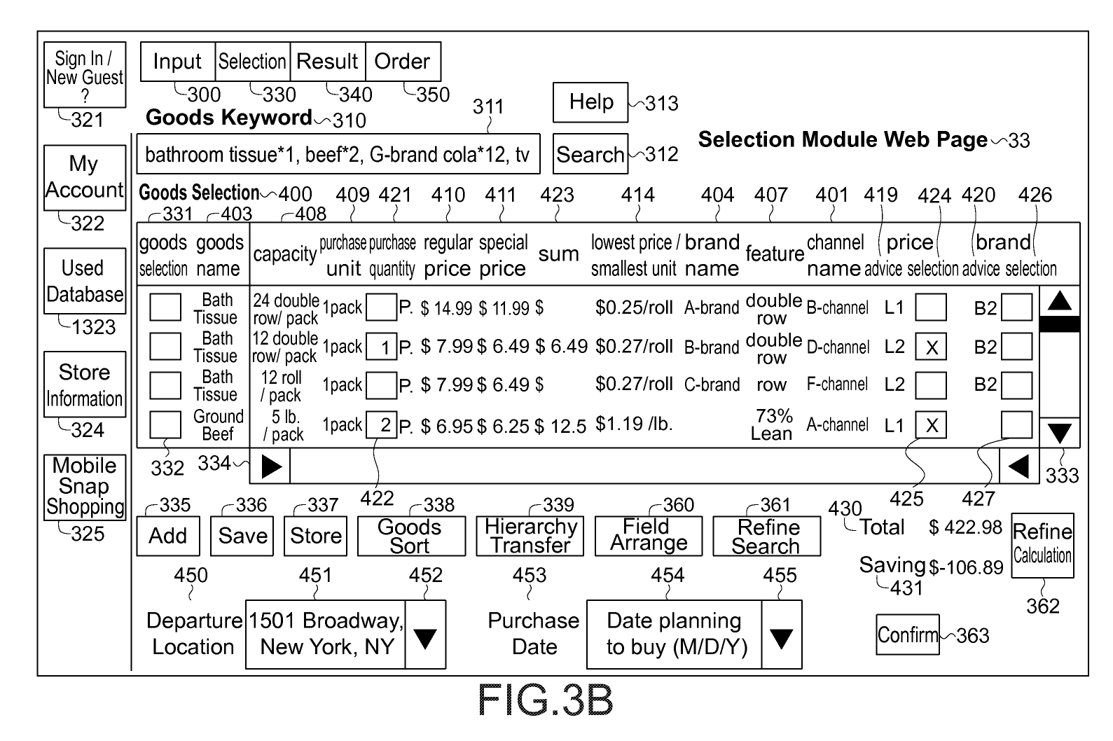

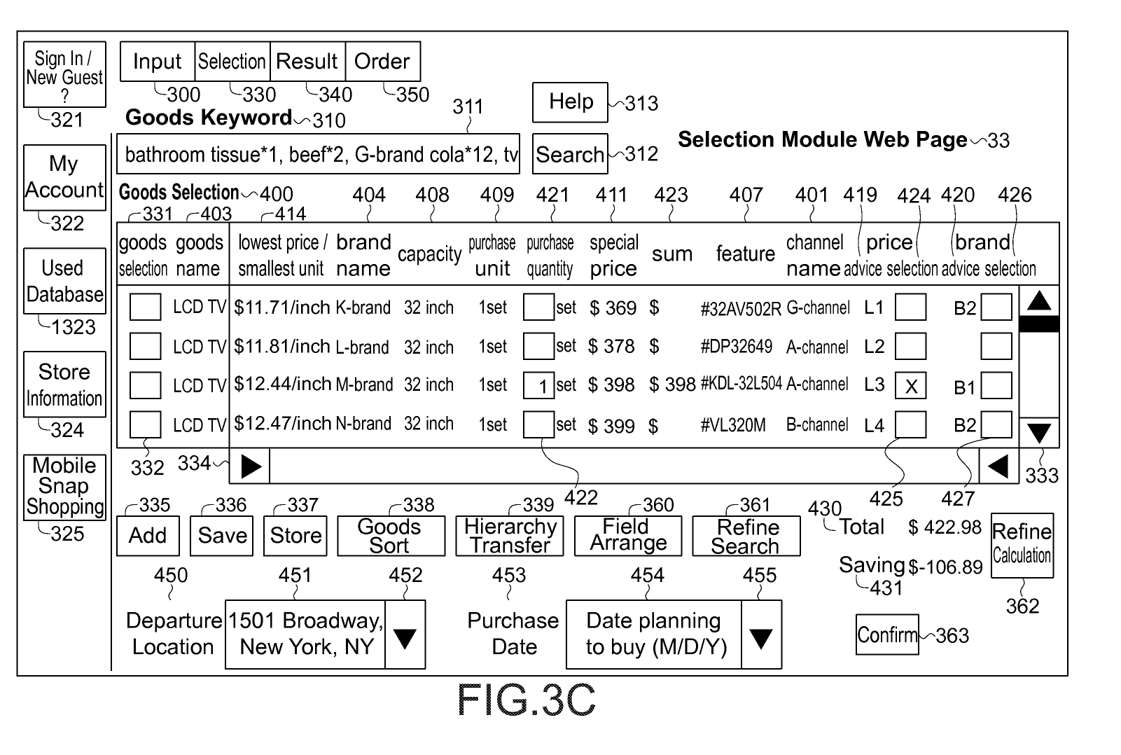

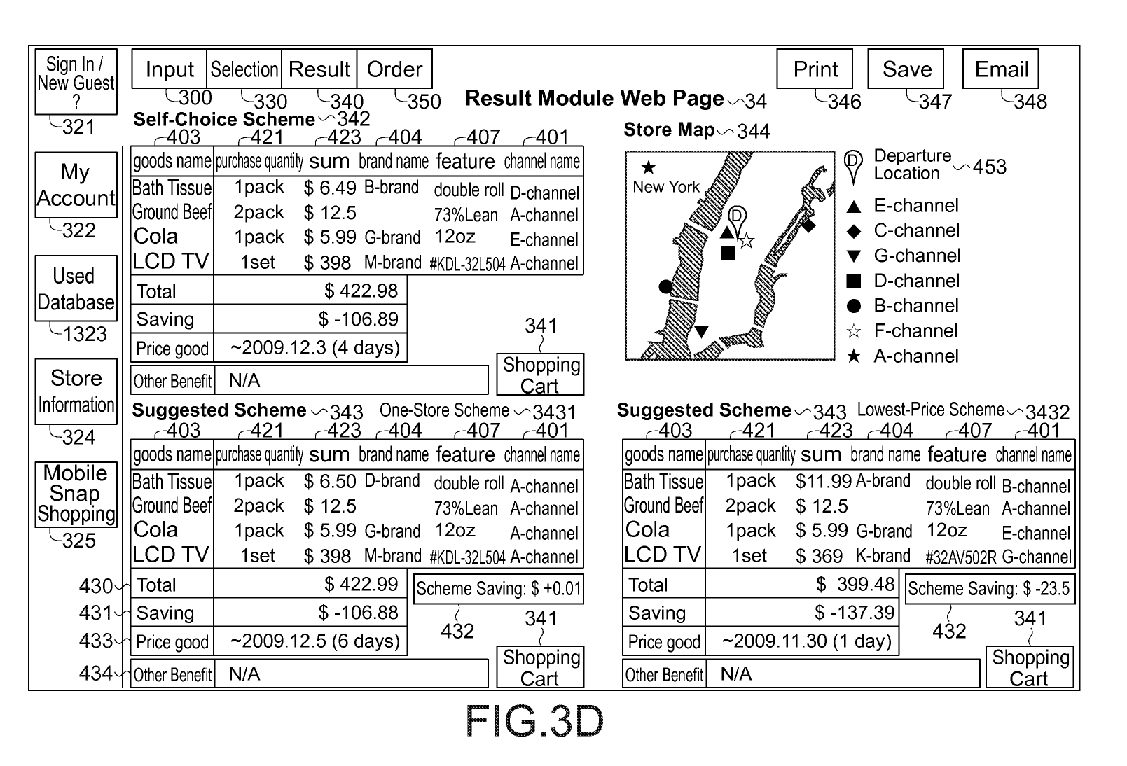

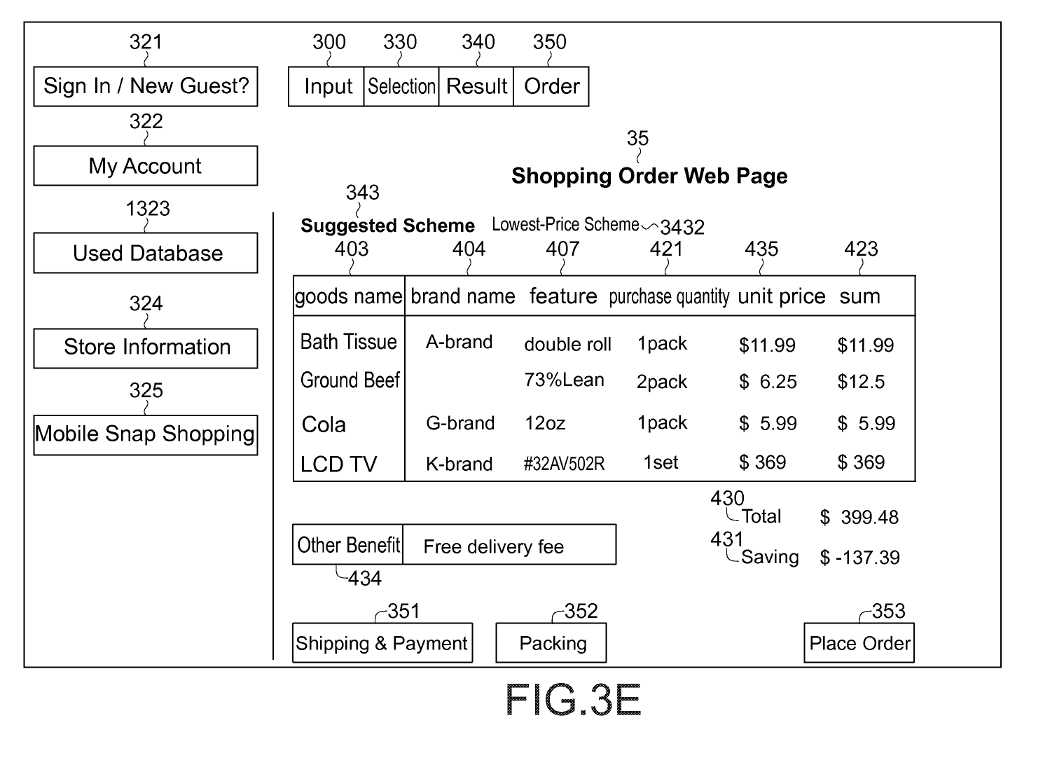

Below Web pages are merely an example and should not limit the scope of the claims herein. One of ordinary skill in the art would recognize other variations, modifications and alternatives. FIG. 3A is an input module Web page according to an embodiment of the present invention. A user types a keyword request of “bathroom tissue*1, beef*2, G-brand cola*12, TV” in a goods keyword block 311, and then clicks a search 312 operation. To take “G-brand cola*12” as an example, the brand name 404 is G-brand, the goods name 403 is cola and the purchase quantity 421 is 12 units. Users may also input information in a departure location block 451 or a purchase date block 454. The user types “1501 Broadway, New York, NY” in the departure location block 451, but not inputs information in the purchase date block 454, therefore, the purchase date is the operating date on Nov. 30, 2009.

The input module 130 receives the keyword request and provides the keyword request as a parameter for performing the search operation. The search module 131 searches goods records according to the keyword request in a database 132 and finds the related goods records. The search module 131 retrieves the related goods records and sets the related goods record as a candidate for performing the selection operation.

FIG. 3B is a selection module Web page according to an embodiment of the present invention. FIG. 4B is another database table according to an embodiment of the present invention. Selection module 133 shows the goods records searched by the search module, such as bathroom tissue, beef, cola and TV in a goods selection 400, receives an input, and performs a corresponding operation according to the input. In bathroom tissue, the user clearly knows A-brand is the cheapest one in B-channel according to field contents of a price advice 419 or a lowest price/smallest unit 414, but it is too many for the user to buy a pack of 24 double rolls. Therefore, the user accepts the 2nd price advice 419 which is B-brand in D-channel and ticks its price selection block 425 to show a cross. Purchase quantity block 422 automatically shows 1 unit cause of a quantity input in the above keyword request.

In beef, the user knows beef is the cheapest one in A-channel according to field contents of the price advice 419 or the lowest price/smallest unit 414. Therefore, the user accepts the 1st price advice 419 which is beef in A-channel and ticks its price selection block 425, and purchase quantity block 422 automatically shows 2 units.

In cola, the user knows G-brand cola is the cheapest one in E-channel according to field contents of a brand advice 420 or the lowest price/smallest unit 414. Therefore, the user accepts the 1st brand advice 420 which is G-brand cola in E-channel and ticks its brand selection block 427. Although a pack of A-brand cola in E-channel is 24 cans and is more 12 cans than the user's shopping plan in the above keyword request, the user still feel 24 cans is acceptable. The user revises the purchase quantity block 422 to 1 unit (i.e. 24 cans) from 12 units.

In TV, the user knows I-brand 23″ TV is the cheapest one in G-channel according to field contents of the price advice 419 or the lowest price/smallest unit 414. However, the user wants to buy a 32″ TV, also wants to see more TVs and also wants to adjust field arrange 360 operation.

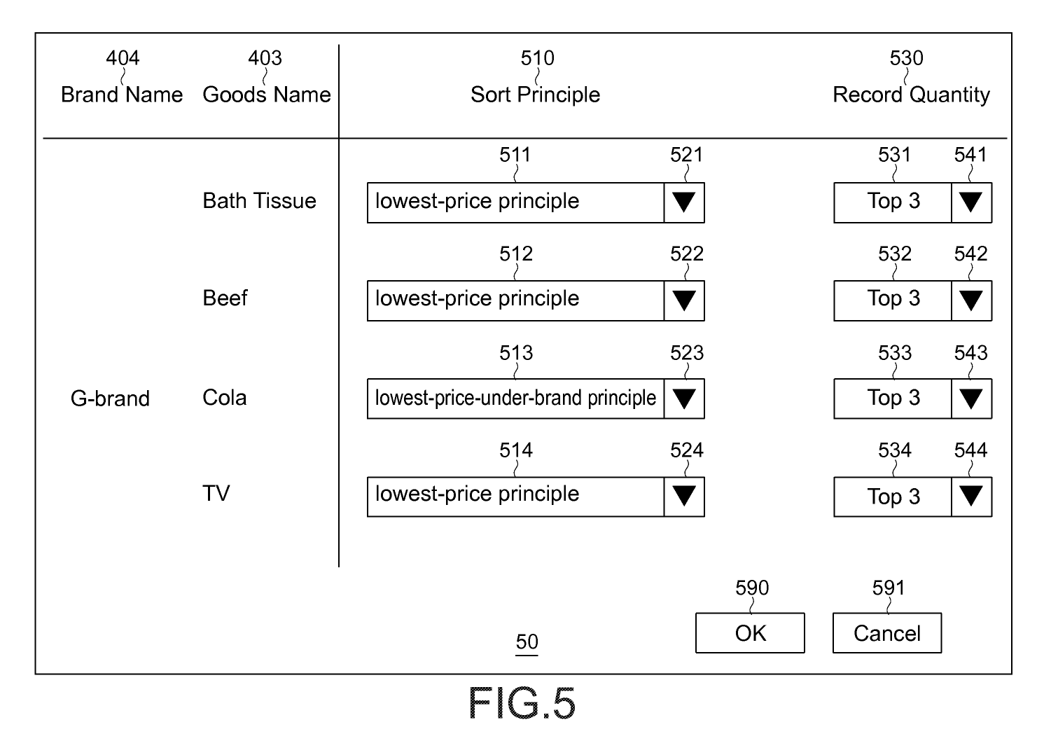

The user clicks a goods sort 338 operation, and then a pop-up window of goods sort operation 50 is displayed. FIG. 5 is a pop-up window of goods sort operation according to an embodiment of the present invention. Regarding to the goods sort 338 operation, in a sort principle 510, bathroom tissue, beef and TV are sorted with a lowest-price principle, because there is no input in brand name 404 in the keyword request. Cola is sorted with a lowest-price-under-brand principle, because there is a “G-brand” input in brand name 404 in the keyword request. In a record quantity 530, the basic setting is to only show “top 3” quantity in each record quantity block in each goods. The user clicks a record quantity control block 544 operation of TV and selects a quantity of “top 7”. The record quantity block 534 of TV is changed to “top 7” from “top 3”. The user clicks an ok 590 operation and then the pop-up window of goods sort operation 50 is closed and a selection module Web page comes back.

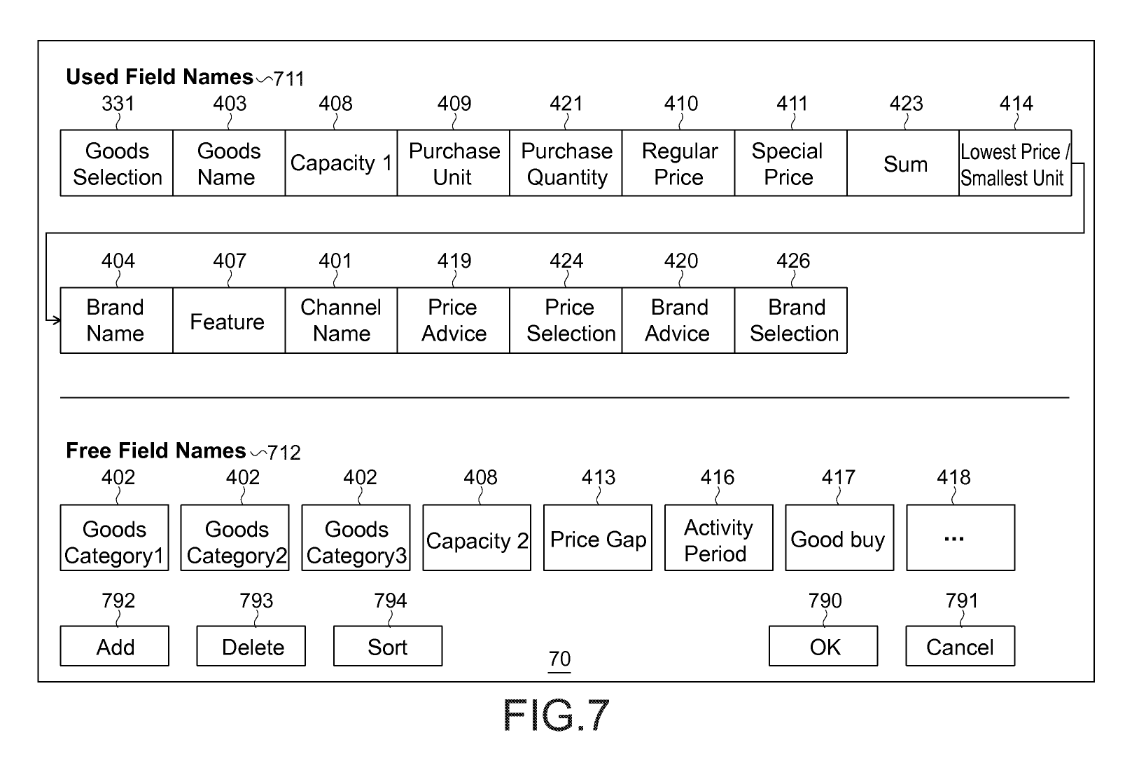

FIG. 7 is a pop-up window of field arrange operation according to an embodiment of the present invention. The user clicks an field arrange 360 operation, and then a pop-up window of field arrange operation 70 is displayed. Used field names 711 means field names are showed, and free field names 712 means field names are not showed in a goods selection 400. The user wants to delete a field name of a regular price 410 and move field names of a lowest price/smallest unit 414 and a brand name 404 to behind of a goods name 403. The user clicks and moves the field name of the regular price 410 to a free field names 712 area, and then moves the field names of the lowest price/smallest unit 414 and the brand name 404 to behind of the goods name 403. The user clicks an ok 790 operation and then the pop-up window of field arrange operation 70 is closed and a selection module Web page comes back.

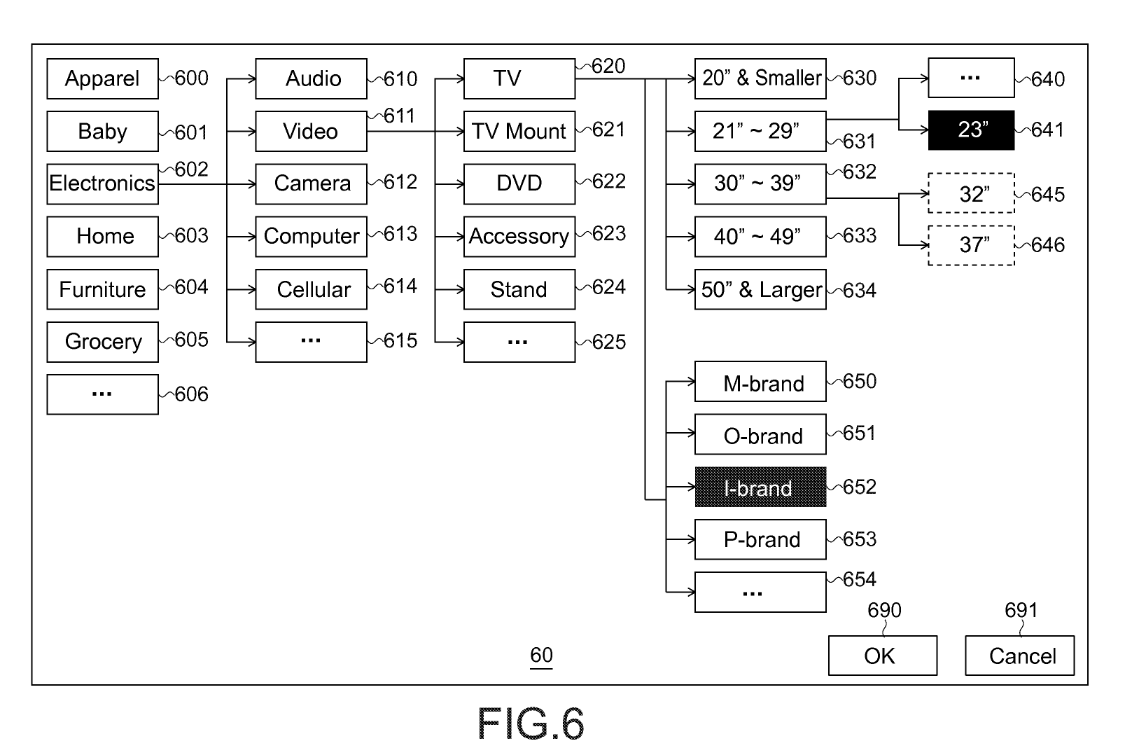

FIG. 6 is a pop-up window of hierarchy transfer operation according to an embodiment of the present invention. The user clicks a goods selection block 332 related to I-brand 23″ TV in G-channel and clicks a hierarchy transfer 339 operation. Then a pop-up window of hierarchy transfer operation 60 is displayed. The pop-up window of hierarchy transfer operation 60 shows a white word with a black background block in a block of 23″ 641 and a block of I-brand 652. While the user moves a mouse cursor to a block of 30″ to 39″ 632, a block of 32″ 645 and a block of 37″ 656 are showed. The user clicks the block of 32″ 645 and clicks an ok 690 operation, and then the pop-up window of hierarchy transfer operation 60 is closed and a selection module Web page comes back.

FIG. 4C is another database table according to an embodiment of the present invention. FIG. 3C is a selection module Web page according to another embodiment of the present invention. Selection module 133 shows revised TV related information under a goods selection 400. The user sees a hot sale in G-channel. Therefore, the user accepts the 3rd price advice 419 which is a famous M-brand 32″ TV in G-channel and ticks its price selection block 425, and types 1 unit in purchase quantity block 422. The user immediately clicks a refine calculation 362 operation, and it is showed that a field content of the total 430 is $ 422.98 and a field content of the saving 431 is $−106.89 saving $106.89 while summing price gap 413 of all selected goods. The user is satisfied and clicks a confirm 363 operation, and then the selection module Web page is closed and a result module Web page 34 is displayed.

Selection module 133 receives the goods records and sets result obtained by performing the corresponding operation as one of candidates for performing the result operation.

FIG. 3D is a result module Web page according to an embodiment of the present invention. A result module Web page 34 of result module 134 includes a self-choice scheme 342 and 3 suggested schemes 343, wherein said 3 suggested schemes 343 includes a one store scheme 3431, a lowest price scheme 3432 and a store map 344. Users may also use an operation of a print 346, a save 347 or a send 348 to make it as a shopping guide while going shopping in a sales channel. After comparing, the user thinks the one store scheme 3431 is the best choice and then clicks a sends 348 operation to send an e-mail to his mailbox for a backup and also send a MMS or SMS to his mobile phone to be a reference while shopping soon. Or after comparing, the user finally thinks the lowest price scheme 3432 is the best choice and wants to buy them online and use a home delivery service; therefore, the user clicks a shopping cart 341 operation of the lowest price scheme 3432. Then, the result module Web page 34 is closed and an order module 135 Web page is displayed.

The selection module 133 receives the suggested scheme and provides the suggested scheme as a parameter for performing the order operation.

FIG. 3E is an order module Web page according to an embodiment of the present invention. An order module Web page 35 of order module 135 includes the lowest price scheme 3432, a shipping & payment 351 operation, a packing 352 operation and a place order 353 operation. The user checks the lowest price scheme 3432 in detail, files the information in the shipping & payment 351 operation and the packing 352 operation, and clicks a place order 353 operation. Order module 135 receives the shopping order.

To summarize the advantages of embodiments of the present invention, firstly, the electronic-ecommerce solution can consolidatedly and apparently show to compare the detailed goods data of plural sales channels and provide a shopping plan to make users spend the least times, go to the nearest and fewest sales channel and buy the cheapest or suitable goods in order to save money, time, effort and energy;

Secondly, the electronic-ecommerce solution can search plural goods once, arrange and compare various goods information and provide a shopping plan;

Thirdly, while users stay and buy goods in an unfamiliar place, such as a travel or biz trip in other cities or abroad, they can know any store nearby through automatically mobile Global Positioning System (GPS) or manually inputted address in the electronic-ecommerce solution, furthermore, also know how to buy wanted goods with the cheapest price in which store nearby. The above situation makes users become smart shoppers everywhere;

Fourthly, the electronic-ecommerce solution can provide users a C2B model only searching wanted goods with a keyword request and getting a needed goods-related information. The above situation makes users easily buy the cheapest and suitable goods, reduce to buy additional goods beyond a shopping plan, and save environmental resource;

Finally, users can concern with a one-store scheme buying a set of goods with the cheapest or cheaper price in a store in order to save money, time, effort and energy and avoid air pollution.

Although the above has been described in terms of specific software and hardware, other variations can exit. For instance, functionality described above can be further integrated or separated using software. The functionality can also be combined with hardware. A combination of hardware and software can be used. Accordingly, the present invention is not to be limited by further embodiments noted above.

The invention has been explained with reference to a further embodiment. Other embodiments will be apparent to those of ordinary skill in the art. It is therefore not intended that this invention be limited, except as indicated by the appended claims.

What is claimed is:

1. A system for managing electronic commerce, said system comprising:
an input module configured to receive at least one keyword request from a user client;
a search module configured to search at least one goods record according to the keyword request in a database or on the Internet;
a selection module configured to show the at least one goods record searched by the search module, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; and
a result module configured to show at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme.

2. The system of claim 1, wherein the database configured to store data with a table and categorize data attribute with at least one field name, wherein the at least one field name comprises at least one of a goods, a brand, a channel, a price, a place, a date, an advice, a picture, an activity and a blank block, wherein the field name of the goods comprises at least one of a goods category, a goods name, a feature, a capacity, a purchase unit and a purchase quantity, wherein the field name of the brand comprises at least one of a brand name, a brand value and a brand value rank, wherein the field name of the channel comprises at least one of a channel name, a store name, a store address, a store telephone and a store operating time, wherein the field name of the price comprises at least one of a regular price, a special price, a club price, a price gap, a lowest price/smallest unit, a sum, a total, an unit price, a saving and a scheme saving, wherein the field name of the place comprises at least one of a departure location and a store address, wherein the field name of the date comprises at least one of a purchase date, an activity period, a good buy and a price good, wherein the field name of the advice comprises at least one of a price advice and a brand advice, wherein the field name of the activity comprises at least one of an activity summary and an activity period, and wherein the field name of the blank block comprises at least one of a goods keyword block, a goods selection block, a purchase quantity block, a price selection block, a brand selection block, a departure location block and a purchase date block.

2.1. The system of claim 1, wherein the operation of the goods sorting comprises at least one of selecting sort principle and selecting record quantity, wherein the selecting sort principle configured to select a sort principle of plural searched goods records of at least one goods, wherein the sort principle comprises one of a lowest-price principle, a lowest-price-under-brand principle, a brand-value principle and a lowest-price-with-highest-brand-value principle, wherein the lowest-price principle sorts the plural searched goods records having the same goods name with field contents of the price in ascending order, wherein the lowest-price-under-brand principle sorts the plural searched goods records having the same brand name and the same goods name with field contents of the price in ascending order, wherein the brand-value principle sorts the plural searched goods records having the same goods name with field contents of the brand value in descending order, wherein the lowest-price-with-highest-brand-value principle sorts the plural searched goods records having the same goods name with field contents of the brand value in descending order and then sort with field contents of the price in ascending order, wherein a field name corresponding to the field contents of the price comprises at least one of a regular price, a special price, a club price, a price gap, a lowest price/smallest unit, a sum, a total, an unit price, a saving and a scheme saving, and wherein the selecting record quantity configured to select for showing a record quantity of the plural searched goods records of each goods.

2.2. The system of claim 1, wherein the operation of the hierarchy transferring configured to show relationships and field contents of hierarchies of the at least one goods record, and provide to transfer a goods hierarchy location within the hierarchies, wherein a field name corresponding to the field contents of the hierarchies comprises at least one of a goods category, a goods name, a feature, a capacity, a purchase unit and a brand name.

2.3. The system of claim 1, wherein the operation of the field arranging configured to arrange a field name in order to change a show of the searched goods records, wherein the arranging comprises one of moving prioritily, adding and reducing, wherein the field name comprises at least one of a goods, a brand, a channel, a price, a place, a date, an advice, a picture, an activity and a blank block, wherein the field name of the goods comprises at least one of a goods category, a goods name, a feature, a capacity, a purchase unit and a purchase quantity, wherein the field name of the brand comprises at least one of a brand name, a brand value and a brand value rank, wherein the field name of the channel comprises at least one of a channel name, a store name, a store address, a store telephone and a store operating time, wherein the field name of the price comprises at least one of a regular price, a special price, a club price, a price gap, a lowest price/smallest unit, a sum, a total, an unit price, a saving and a scheme saving, wherein the field name of the place comprises at least one of a departure location and a store address, wherein the field name of the date comprises at least one of a purchase date, an activity period, a good buy and a price good, wherein the field name of the advice comprises at least one of a price advice and a brand advice, wherein the field name of the activity comprises at least one of an activity summary and an activity period, and wherein the field name of the blank block comprises at least one of a goods keyword block, a goods selection block, a purchase quantity block, a price selection block, a brand selection block, a departure location block and a purchase date block.

3. A system for managing electronic commerce, said system comprising:
an input module configured to receive at least one keyword request from a user client;
a search module configured to search at least one goods record according to the keyword request, and perform a corresponding operation under the at least one goods record; and
a result module configured to show at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map.

4. A method for managing electronic commerce, said method comprising:
performing an input operation, receiving at least one keyword request;
performing a search operation, searching at least one goods record according to the keyword request in a database or on the Internet;
performing a selection operation, showing the at least one goods record searched by the search operation, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; and
performing a result operation, showing at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme.

4.1. The method of claim 4, wherein said input operation comprises:
receiving the at least one keyword request;
determining whether receiving a response or not;
still waiting for the response if the response is not received; and
receiving the keyword request and providing the keyword request as a parameter for performing the search operation if the response is received.

5. The method of claim 4, wherein said search operation comprises:
searching at least one goods record according to the keyword request in the database or on the Internet;
determining whether related goods record is found according to the keyword request;
showing could not finding matches for the keyword request if the related goods record is not found; and
retrieving the related goods record and setting the related goods record as a candidate for performing the selection operation if the related goods record is found.

6. The method of claim 4, wherein said selection operation comprises:
showing at least one goods record searched by the search operation;
determining whether receiving a response or not;
still waiting for the response if the response is not received;
waiting for further response after performing the corresponding operation designated by the received response if the response is received and the received response designated the corresponding operation other than the confirming operation; and
setting result obtained by performing the corresponding operation as one of candidates for performing the result operation if the response is received and the received response designated the confirming operation.

6.1. The method of claim 4, wherein the operation of the goods sorting comprises at least one of selecting sort principle and selecting record quantity, wherein the selecting sort principle configured to select a sort principle of plural searched goods records of at least one goods, wherein the sort principle comprises one of a lowest-price principle, a lowest-price-under-brand principle, a brand-value principle and a lowest-price-with-highest-brand-value principle, wherein the lowest-price principle sorts the plural searched goods records having the same goods name with field contents of the price in ascending order, wherein the lowest-price-under-brand principle sorts the plural searched goods records having the same brand name and the same goods name with field contents of the price in ascending order, wherein the brand-value principle sorts the plural searched goods records having the same goods name with field contents of the brand value in descending order, wherein the lowest-price-with-highest-brand-value principle sorts the plural searched goods records having the same goods name with field contents of the brand value in descending order and then sort with field contents of the price in ascending order, wherein a field name corresponding to the field contents of the price comprises at least one of a regular price, a special price, a club price, a price gap, a lowest price/smallest unit, a sum, a total, an unit price, a saving and a scheme saving, and wherein the selecting record quantity configured to select for showing a record quantity of the plural searched goods records of each goods.

6.2. The method of claim 4, wherein the operation of the hierarchy transferring configured to show relationships and field contents of hierarchies of the at least one goods record, and provide to transfer a goods hierarchy location within the hierarchies, wherein a field name corresponding to the field contents of the hierarchies comprises at least one of a goods category, a goods name, a feature, a capacity, a purchase unit and a brand name.

6.3. The method of claim 4, wherein the operation of the field arranging configured to arrange a field name in order to change a show of the searched goods records, wherein the arranging comprises one of moving prioritily, adding and reducing, wherein the field name comprises at least one of a goods, a brand, a channel, a price, a place, a date, an advice, a picture, an activity and a blank block, wherein the field name of the goods comprises at least one of a goods category, a goods name, a feature, a capacity, a purchase unit and a purchase quantity, wherein the field name of the brand comprises at least one of a brand name, a brand value and a brand value rank, wherein the field name of the channel comprises at least one of a channel name, a store name, a store address, a store telephone and a store operating time, wherein the field name of the price comprises at least one of a regular price, a special price, a club price, a price gap, a lowest price/smallest unit, a sum, a total, an unit price, a saving and a scheme saving, wherein the field name of the place comprises at least one of a departure location and a store address, wherein the field name of the date comprises at least one of a purchase date, an activity period, a good buy and a price good, wherein the field name of the advice comprises at least one of a price advice and a brand advice, wherein the field name of the activity comprises at least one of an activity summary and an activity period, and wherein the field name of the blank block comprises at least one of a goods keyword block, a goods selection block, a purchase quantity block, a price selection block, a brand selection block, a departure location block and a purchase date block.

7. A method for managing electronic commerce, said method comprising:
performing an input operation, receiving at least one keyword request;
performing a search operation, searching at least one goods record according to the keyword request, and perform a corresponding operation under the at least one goods record; and
performing a result operation, showing at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map.

8. The method of claim 7, wherein said search operation comprises:
searching at least one goods record according to the keyword request;
determining whether related goods record is found according to the keyword request;
showing could not finding matches for the keyword request if the related goods record is not found; and
retrieving the related goods record and setting the related goods record as one of candidates for performing the result operation if the related goods record is found.

9. The method of claim 7, wherein said input operation comprises:
receiving the at least one keyword request;
determining whether receiving a response or not;
still waiting for the response if the response is not received; and
receiving the keyword request and providing the keyword request as a parameter for performing the search operation if the response is received.

10. A computer-readable medium tangibly embodying a program of machine-readable instructions executable by a digital processing apparatus to perform a method of managing electronic commerce, said method comprising:
performing an input operation, receiving at least one keyword request;
performing a search operation, searching at least one goods record according to the keyword request in a database or on the Internet;
performing a selection operation, showing the at least one goods record searched by the search operation, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; and
performing a result operation, showing at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme.

11. A computer-readable medium tangibly embodying a program of machine-readable instructions executable by a digital processing apparatus to perform a method of managing electronic commerce, said method comprising:
performing an input operation, receiving at least one keyword request;
performing a search operation, searching at least one goods record according to the keyword request, and perform a corresponding operation under the at least one goods record; and
performing a result operation, showing at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map.

12. A computer program product for managing electronic commerce, said computer program product comprising:
a computer usable medium having computer usable program code embodied therewith, the computer usable program code comprising computer usable program code configured to:
performing an input operation, receiving at least one keyword request;
performing a search operation, searching at least one goods record according to the keyword request in a database or on the Internet;
performing a selection operation, showing the at least one goods record searched by the search operation, receive an input, and perform a corresponding operation according to the input, wherein the corresponding operation comprises at least one of adding, saving, store inputting, goods sorting, hierarchy transferring, field arranging, refine searching, refine calculating, goods selecting, purchase quantity inputting, price selecting, brand selecting, departure location inputting, purchase date inputting and confirming; and
performing a result operation, showing at least one shopping plan got from the correspondingly operation, wherein the at least one shopping plan comprises at least one of a self-choice scheme and at last one suggested scheme, wherein the at least one suggested scheme comprises at least one of an one-store scheme, a lowest-price scheme, a best-brand-value scheme, a fewest-and-nearest-plural-stores scheme and a store map, and wherein the self-choice scheme is a set of records of plural goods sold in plural sales channels while the at least one shopping plan comprises only one self-choice scheme.

13. A computer program product for managing electronic commerce, said computer program product comprising:
a computer usable medium having computer usable program code embodied therewith, the computer usable program code comprising computer usable program code configured to:
performing an input operation, receiving at least one keyword request;
performing a search operation, searching at least one goods record according to the keyword request, and perform a corresponding operation under the at least one goods record; and
performing a result operation, showing at least one suggested scheme got from the correspondingly operation, wherein the at least one suggested scheme comprises at least one of an one-store scheme, a lowest-price scheme, a best-brand-value scheme, a fewest-and-nearest-plural-stores scheme and a store map.

13.1. A computer program product for managing electronic commerce, said computer program product comprising:
a computer usable medium having computer usable program code embodied therewith, the computer usable program code comprising computer usable program code configured to:
selecting a sort principle of plural searched goods records of at least one goods, wherein the sort principle comprises one of a lowest-price principle, a lowest-price-under-brand principle, a brand-value principle and a lowest-price-with-highest-brand-value principle, wherein the lowest-price principle sorts the plural searched goods records having the same goods name with field contents of the price in ascending order, wherein the lowest-price-under-brand principle sorts the plural searched goods records having the same brand name and the same goods name with field contents of the price in ascending order, wherein the brand-value principle sorts the plural searched goods records having the same goods name with field contents of the brand value in descending order, wherein the lowest-price-with-highest-brand-value principle sorts the plural searched goods records having the same goods name with field contents of the brand value in descending order and then sort with field contents of the price in ascending order, and wherein a field name corresponding to the field contents of the price comprises at least one of a regular price, a special price, a club price, a price gap, a lowest price/smallest unit, a sum, a total, an unit price, a saving and a scheme saving.

14-17. (canceled)

18. A method for managing electronic commerce, said method comprising:
selecting a sort principle of plural searched goods records of at least one goods, wherein the sort principle comprises one of a lowest-price principle, a lowest-price-under-brand principle, a brand-value principle and a lowest-price-with-highest-brand-value principle, wherein the lowest-price principle sorts the plural searched goods records having the same goods name with field contents of the price in ascending order, wherein the lowest-price-under-brand principle sorts the plural searched goods records having the same brand name and the same goods name with field contents of the price in ascending order, wherein the brand-value principle sorts the plural searched goods records having the same goods name with field contents of the brand value in descending order, wherein the lowest-price-with-highest-brand-value principle sorts the plural searched goods records having the same goods name with field contents of the brand value in descending order and then sort with field contents of the price in ascending order, and wherein a field name corresponding to the field contents of the price comprises at least one of a regular price, a special price, a club price, a price gap, a lowest price/smallest unit, a sum, a total, an unit price, a saving and a scheme saving.

19. A method for managing electronic commerce, said method comprising:
showing at least one suggested scheme, wherein the at least one suggested scheme comprises at least one of a one-store scheme, a lowest-price scheme, a best-brand-value scheme, a fewest-and-nearest-plural-stores scheme and a store map.
